(19) United States
(12) Patent Application Publication
(10) Pub. No.: US 2014/0044370 A1
(43) Pub. Date: Feb. 13, 2014

(54) IMAGE COMPRESSING APPARATUS AND IMAGE DECOMPRESSING APPARATUS

(71) Applicant: FUJITSU LIMITED, Kawasaki-shi (JP)

(72) Inventor: JUNICHI ODAGIRI, Kawasaki (JP)

(73) Assignee: FUJITSU LIMITED, Kawasaki-shi (JP)

(21) Appl. No.: 14/058,677

(22) Filed: Oct. 21, 2013

Related U.S. Application Data
(63) Continuation of application No. PCT/JP2011/061662, filed on May 20, 2011.

(51) Int. Cl. G06T 9/00

(52) U.S. Cl. CPC G06T 9/004
USPC 382/238

(57) ABSTRACT

A processor generates a prediction error by predicting a pixel value of a prediction-target pixel in a compression-target image, and predicts a code amount of compression code for a compression-target line in the compression-target image. According to the predicted code amount and a code amount of compression code for one or more compressed lines, the processor determines which of lossless compression and lossy compression is to be applied to the compression-target line. When the processor determines that lossless compression is to be applied, the processor generates the compression code for the compression-target line by compressing a prediction error for each compression-target pixel in the compression-target line via lossless compression.

### CROSS-REFERENCE TO RELATED APPLICATION

This application is a continuation application of International Application PCT/JP2011/061662 filed on May 20, 2011 and designated the U.S., the entire contents of which are incorporated herein by reference.

### FIELD

The embodiments discussed herein are related to an image compressing apparatus and an image decompressing apparatus, both of which utilize a prediction coding scheme.

### BACKGROUND

Image compressing technologies for decreasing data volume by compressing image data have been used for instruments of various fields, and one of the fields is the field of in-vehicle apparatuses. To apply an image compressing technology to moving images displayed by an in-vehicle apparatus, the following conditions are desirably satisfied.

(1) High Picture Quality

It is preferable that both natural images and computer graphics (CG) images achieve a high picture quality. Known image information addressed by in-vehicle apparatuses includes natural images represented by, for example, typical television images and movies, and CG images (digital images) represented by, for example, a map on a car navigation system. These images have greatly different properties: natural images include many low-frequency components, and digital images include many high-frequency components. Recent in-vehicle apparatuses and recent mobile terminals, including cellular phones, address both digital images such as a map and natural images such as television images and movies, and an effective image compressing technology has been desired for such images having different properties.

(2) Low Delay

Video information is typically transmitted over an in-vehicle Local Area Network (LAN). So that a person on a front seat and another person on a rear seat of a vehicle can see equal images without time lag, it is preferable that only a short time be spent in performing a compressing process, a transmitting process, and a decompressing process with a low delay.

(3) Light Weight

For multiplex transmission, each LAN terminal includes a compressing apparatus and a decompressing apparatus, so the circuit of each apparatus is preferably to be small-sized and light in weight.

One known image compressing technology is a prediction coding scheme wherein a pixel value is predicted for each pixel, such as the Differential Pulse Code Modulation (DPCM). The image compressing technology that relies on a prediction coding scheme may change the size of a quantization step so that a generated-code amount can be precisely adjusted for both images having different properties, such as a natural image and a CG image.

FIG. 1 illustrates an image compressing process that relies on a conventional prediction coding scheme. When image data 101 that is a target to be compressed is input, a predictor 102 predicts the pixel value of a target pixel from the pixel values of neighboring pixels, and outputs the difference between the actual pixel value and the predicted value as a prediction error.

In the case of, for example, plane prediction, as illustrated in FIG. 2, a pixel value X of a target pixel 214 on a focused-on line 202 is predicted using the pixel value of an adjacent pixel 213 on the focused-on line 202 and the pixel values of adjacent pixels 211 and 212 on a preceding line 201. A predicted value X′ of the target pixel 214 is determined with the following formula, where the pixel values of the pixels 213, 211, and 212 are respectively A, B, and C.

X′=A+C−B (1)

In this case, the prediction is made on the assumption that the image is generally flat and that the pixel values of the adjacent pixels are approximately close to each other.

Next, a quantizer 103 quantizes and converts a prediction error X-X′ into a representative value. The representative value changes for the same image data 101 in accordance with the extent of a quantization step size used by the quantizer 103.

Subsequently, a variable-length coder 104 generates a compression code by assigning a variable-length code that depends on the frequency of appearance of the representative value. Typically, the code length of a variable-length code is inversely proportional to the frequency of appearance, so different representative values each lead to a different code length. Thus, the compression efficiency of the same image data 101 changes with the extent of a quantization step size.

Using a quantizer with a small-size quantization step leads to a small quantization error, so the image quality becomes good but the compression efficiency is lowered. Meanwhile, using a quantizer with a large-size quantization step leads to a short total sum of code lengths, thereby improving the compression efficiency, but the image quality worsens due to a large quantization error.

A coding efficiency is different for each prediction algorithm used by a predictor, so switching between a plurality of predictors of different kinds may possibly improve even the compressibility of images having different characteristics. However, the code amount of generated code is different for each kind of predictor.

An image compressing apparatus is known that, according to such properties of predictors and quantizers, switches between a plurality of kinds of predictors and between a plurality of kinds of quantizers in order to satisfy the conditions of a high image quality, low delay, and light weight. In the applying of a line-direction prediction coding scheme, the image compressing apparatus selectively switches between respective different predictors for a natural image and a CG image. Before a compressing process, the apparatus may widely estimate (for each line) a prediction error that would be caused by the switching of a predictor, and may determine a quantizer to be used according to the result of the estimating. Accordingly, the code amount of compression code may be adjusted without locally causing image degradation.

Patent document 1: International Publication Pamphlet No. WO 2009/157047

### SUMMARY

According to an aspect of the embodiments, an image compressing apparatus that utilizes a prediction coding scheme includes a processor.

The processor predicts a pixel value of a prediction-target pixel in a compression-target image, and predicts a code amount of compression code for a compression-target line in the compression-target image. According to the predicted code amount and a code amount of compression code for one or more compressed lines, the processor determines which of lossless compression and lossy compression is to be applied to the compression-target line. When the processor determines that lossless compression is to be applied, the processor generates the compression code for the compression-target line by compressing a prediction error for each prediction-target pixel in the compression-target line via lossless compression.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an image compressing process that relies on a conventional prediction coding scheme.

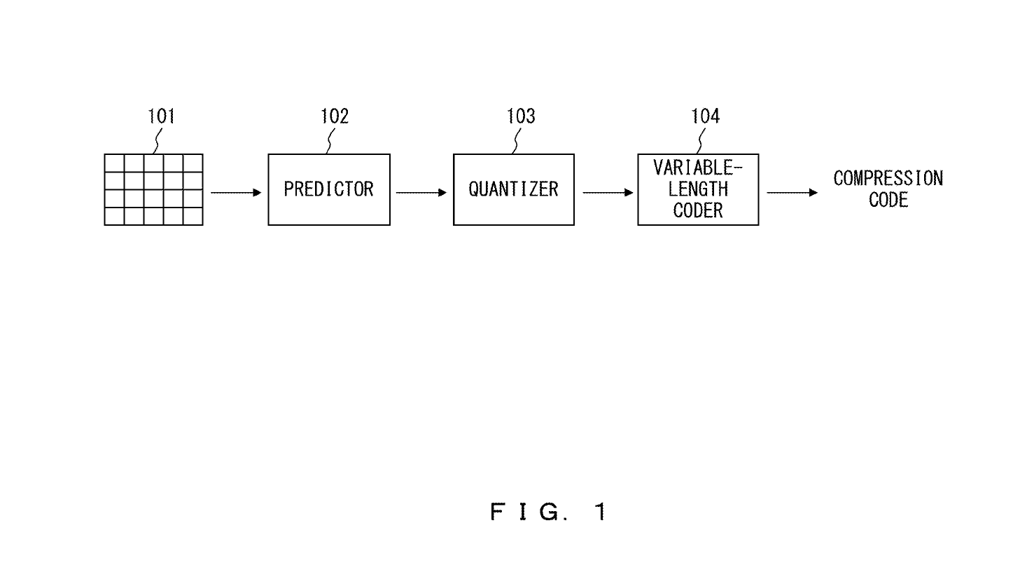

FIG. 2 illustrates plane prediction.

FIG. 3 illustrates a pattern used for a navigation image.

FIG. 4 illustrates a functional configuration diagram of an image processing system.

FIG. 5 illustrates a functional configuration diagram of an image compressing apparatus.

FIG. 6 illustrates a quantization table.

FIG. 7 illustrates a flowchart of an image compressing process.

FIG. 8 illustrates a flowchart of a wide-area-mode determination.

FIG. 9 illustrates a functional configuration diagram of a first line-code-amount predicting unit.

FIG. 10 illustrates a functional configuration diagram of a second line-code-amount predicting unit.

FIG. 11 illustrates a functional configuration diagram of a third line-code-amount predicting unit.

FIG. 12 illustrates a flowchart of a local mode determination.

FIG. 13 illustrates a functional configuration diagram of a first pixel-value comparing unit.

FIG. 14 illustrates a functional configuration diagram of a second pixel-value comparing unit.

FIG. 15 illustrates a functional configuration diagram of a third pixel-value comparing unit.

FIG. 16 illustrates a first change in a generated-code amount.

FIG. 17 illustrates a second change in a generated-code amount.

FIG. 18 illustrates a third change in a generated-code amount.

FIG. 19 illustrates a functional configuration diagram of an image decompressing apparatus.

FIG. 20 illustrates an inverse quantization table.

FIG. 21 illustrates a flowchart of an image decompressing process.

FIG. 22 illustrates a configuration diagram of an information processing apparatus.

### DESCRIPTION OF EMBODIMENTS

The aforementioned conventional image compressing apparatus has the following problems.

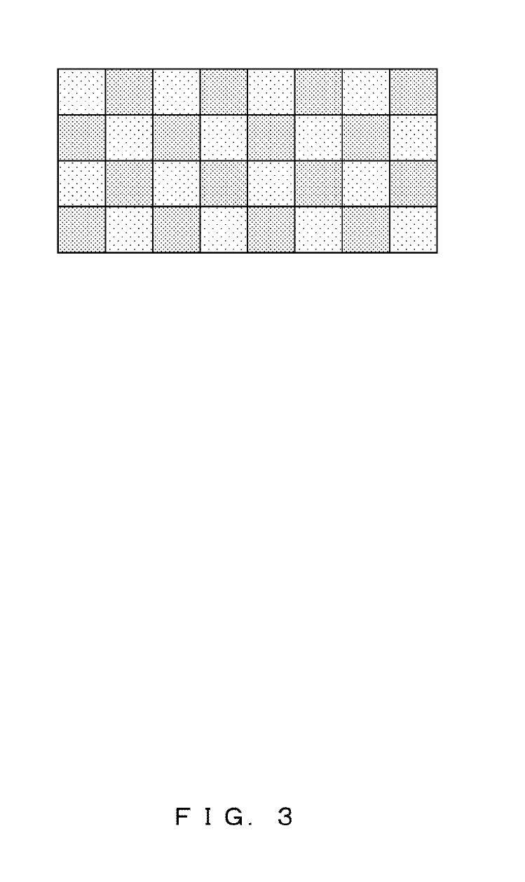

Geometric patterns may be used as a navigation image displayed on an in-vehicle apparatus in order to express gradations in a map. Such geometric patterns include checks such as the one illustrated in FIG. 3, in which pixels have pixel values with small differences.

In the case of such a navigation image, the code amount of compression code often becomes small. However, due to the small code amount, even when a quantizer with a small-size quantization step is selected, the original geometric pattern may be disrupted, thereby making slight image-quality degradation highly noticeable. In this case, lossless compression is desirably applied rather than the lossy compression associated with quantization.

As in the case of navigation images, in order to prevent image-quality degradation in an image restored from compression codes, lossless compression is desirably applied to as many regions as possible within a compression-target image.

In the following, embodiments will be described in detail with reference to the drawings.

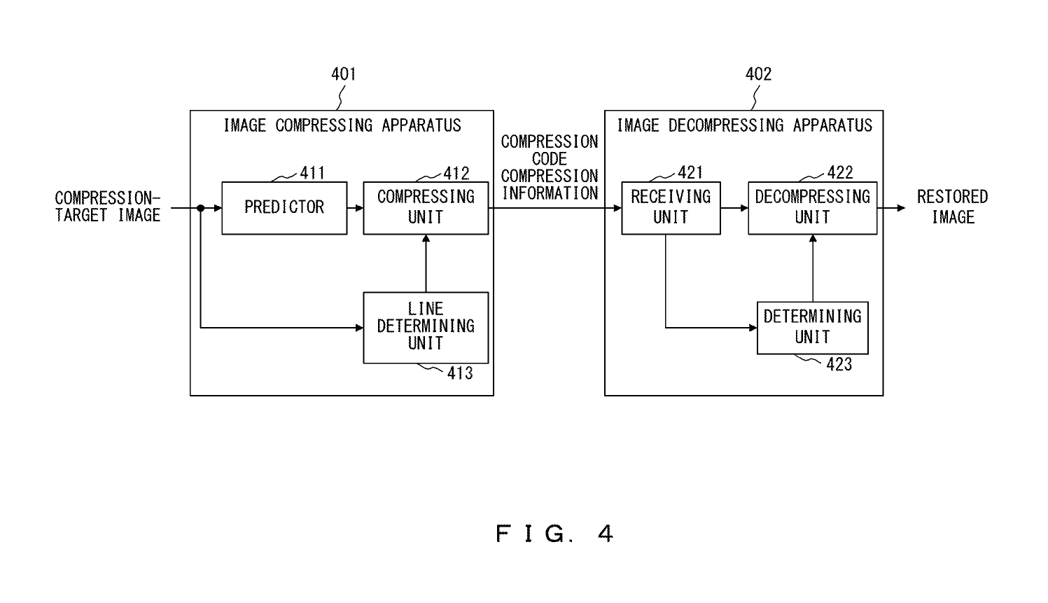

FIG. 4 illustrates an exemplary functional configuration of an image processing system in accordance with an embodiment. The image processing system of FIG. 4 includes an image compressing apparatus 401 and an image decompressing apparatus 402. The image compressing apparatus 401 includes a predictor 411, a compressing unit 412, and a line determining unit 413; the image decompressing apparatus 402 includes a receiving unit 421, a decompressing unit 422, and a determining unit 423.

The predictor 411 predicts the pixel value of a prediction-target pixel within a compression-target image so as to output a prediction error. The line determining unit 413 predicts the code amount of compression code for a compression-target line within the compression-target image. Then, according to the predicted code amount and the code amount of compression code for one or more compressed lines, the line determining unit 413 determines which of lossless compression and lossy compression is to be applied to the compression-target line. When the line determining unit 413 determines that lossless compression is to be applied, the compressing unit 412 generates compression code for the compression-target line by compressing a prediction error for each prediction-target pixel in the compression-target line via lossless compression.

The receiving unit 421 receives the compression code for the compression-target line, and compression information that indicates the result of the determination as to which of lossless compression and lossy compression is to be applied. The determining unit 423 determines which of lossless compression and lossy compression is indicated by the compression information. When the compression information indicates lossless compression, the decompressing unit 422 restores the image of the compression-target line from the compression code for the compression-target line via lossless decompression.

Such an image processing system allows lossless compression to be applied to a compression-target line with an expectedly small generated-code amount within the compression-target image, thereby preventing image-quality degradation in an image restored from the compression-target line.

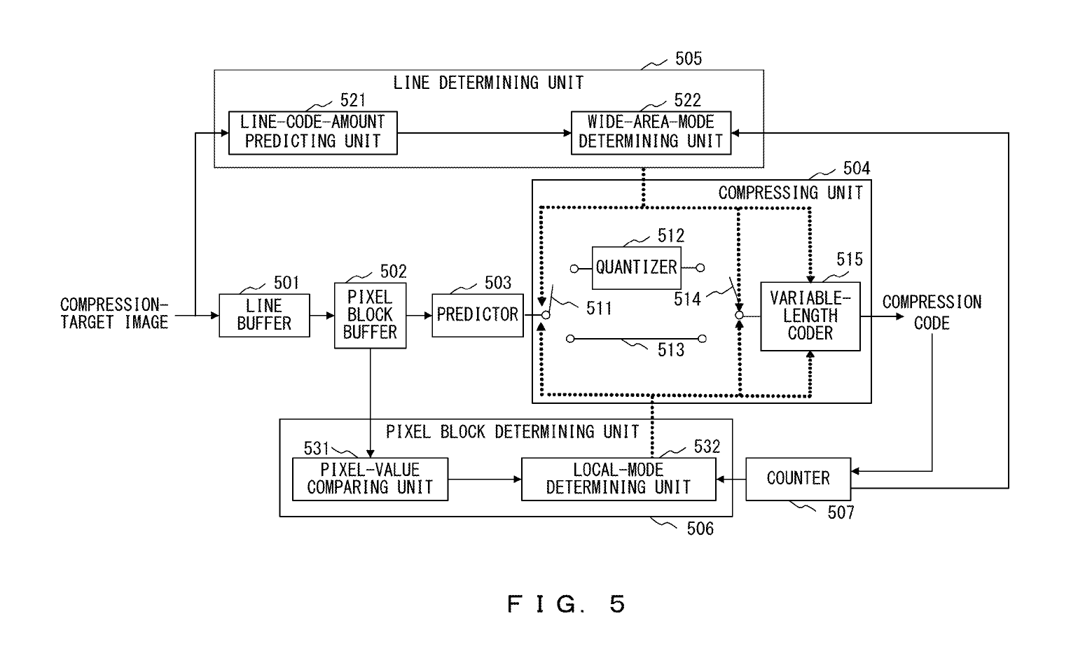

FIG. 5 illustrates another exemplary functional configuration of an image compressing apparatus. The image compressing apparatus in FIG. 5 includes a line buffer 501, a pixel block buffer 502, a predictor 503, a compressing unit 504, a line determining unit 505, a pixel block determining unit 506, and a counter 507.

The compressing unit 504 includes selecting units 511 and 514, a quantizer 512, a non-quantization path 513, and a variable-length coder 515. The line determining unit 505 includes a line-code-amount predicting unit 521 and a wide-area-mode determining unit 522, and the pixel block determining unit 506 includes a pixel-value comparing unit 531 and a local-mode determining unit 532.

An input compression-target image is a collection of pixels, and the pixels are input to the line buffer 501 and the line determining unit 505 in accordance with a line-direction order within a screen.

The line buffer 501 stores, as a compression-target line, the pixel values of one line of pixels in an input compression-target image. One line includes a plurality of pixel blocks. The pixel block buffer 502 stores, as a compression-target pixel block, the pixel values of one block of pixels of the compression-target line stored in the line buffer 501. One block includes one or more pixels.

For example, a pixel block composed of 8 pixels corresponds to a region of 1 vertical pixel×8 horizontal pixels, and a pixel block composed of 16 pixels corresponds to a region of 1 vertical pixel×16 horizontal pixels. A pixel block composed of 1 pixel is identical with the pixel itself.

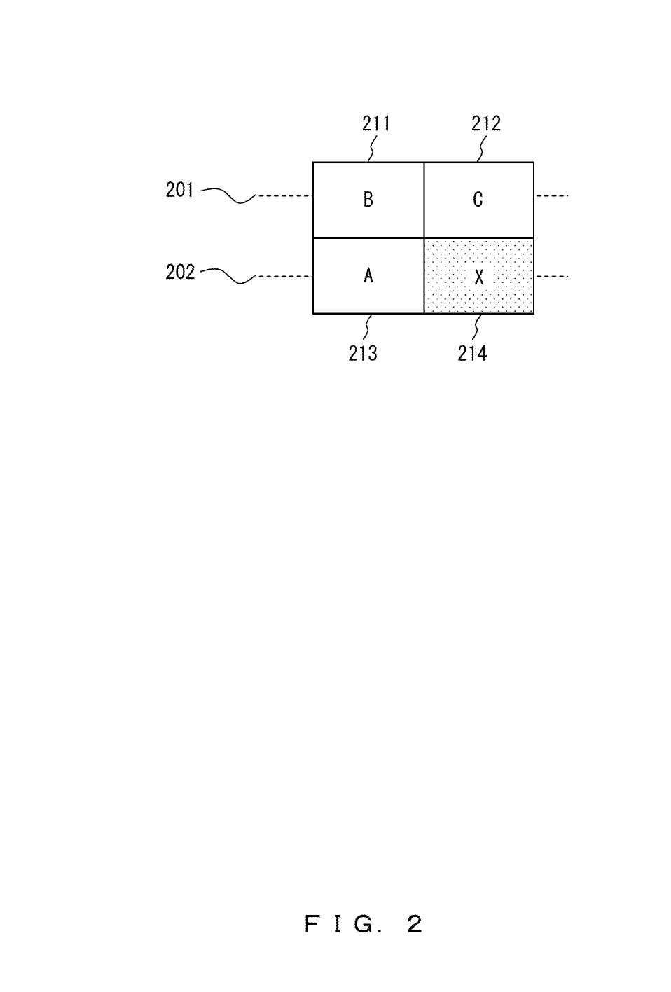

Under a condition in which each pixel of the compression-target pixel block stored in the pixel block buffer 502 is a prediction-target pixel, the predictor 503 predicts the pixel value of the prediction-target pixel according to a predetermined prediction algorithm and outputs a prediction error. The prediction algorithm may be, for example, the plane prediction illustrated in FIG. 2, prediction with a pixel four pixels before, or prediction with a pixel eight pixels before, or another prediction algorithm may be used.

The selecting units 511 and 514 select one of the quantizer 512 and the non-quantization path 513 according to a result of determinations made by the wide-area-mode determining unit 522 and the local-mode determining unit 532. The quantizer 512 quantizes the prediction error so as to output a quantization result, and the non-quantization path 513 directly outputs the prediction error. The variable-length coder 515 converts the quantization result or the prediction error into a variable-length code so as to generate compression code.

The counter 507 counts the code amount of compression code that has been output by the variable-length coder 515 after the start of the compressing of the compression-target image, and outputs this counted code amount to the line determining unit 505 and the pixel block determining unit 506 as a generated-code amount.

The line-code-amount predicting unit 521 of the line determining unit 505 predicts the code amount of compression code generated from one line (a compression-target line) of an input compression-target image, and outputs the predicted generated-code amount to the wide-area-mode determining unit 522. The wide-area-mode determining unit 522 determines the compression mode of the compression-target line according to the predicted generated-code amount and the generated-code amount output by the counter 507.

Providing the line buffer 501 allows a compressing process on a compression-target line to be delayed until the line determining unit 505 determines the compression mode of the compression-target line.

The pixel-value comparing unit 531 of the pixel block determining unit 506 compares the pixel value of each pixel of the compression-target pixel block stored in the pixel block buffer 502 with the pixel values of neighboring pixels around the pixel. Then, the cumulative total value indicative of the cumulative total of the comparison results of all of the pixels of the compression-target block is output to the local-mode determining unit 532. The local-mode determining unit 532 determines the compression mode of the compression-target pixel block according to the cumulative total value and the generated-code amount output from the counter 507.

Providing the pixel block buffer 502 allows a compressing process on a compression-target block to be delayed until the pixel block determining unit 506 determines the compression mode of the compression-target block.

Not only for each line but also for each pixel block, such an image compressing apparatus may determine which of lossless compression and lossy compression is to be applied.

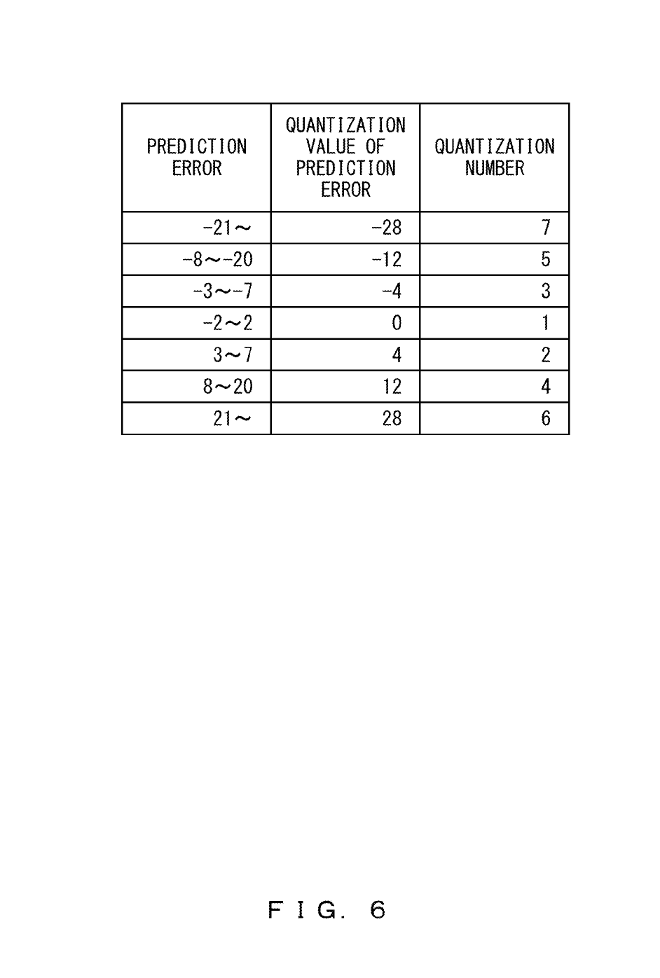

FIG. 6 illustrates an exemplary quantization table used for quantization by the quantizer 512. According to a quantization step size set in the quantization table, the quantizer 512 converts a prediction error into a corresponding quantization value and a corresponding quantization number. Values different from those in FIG. 6 may be used as the size of a quantization step, a quantization value, and a quantization number for quantizing a prediction error.

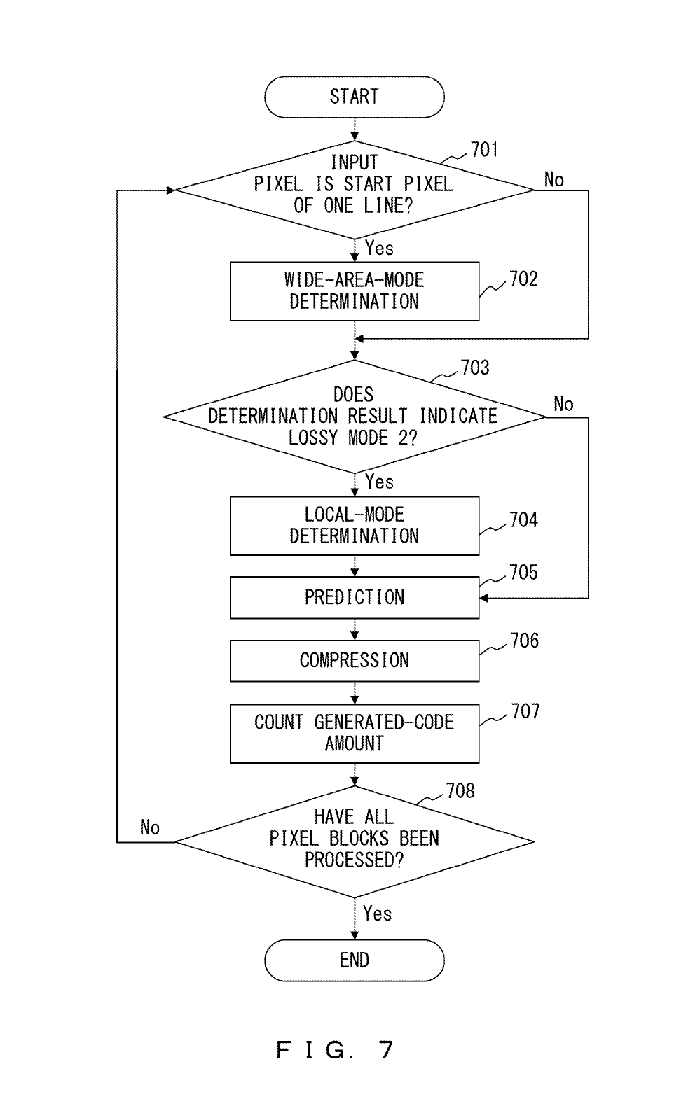

FIG. 7 is a flowchart illustrating an exemplary image compressing process by the image compressing apparatus in FIG. 5. First, the line determining unit 505 determines whether or not an input pixel is a start pixel of one line (step 701). When the input image is the start pixel of one line (Yes in step 701), a wide-area-mode determination is made, and a determination result is output (step 702). The determination result of the wide-area-mode determination indicates any of a lossy mode 1, a lossy mode 2, and a lossless mode.

Next, the pixel block determining unit 506 determines whether or not the determination result of the wide-area-mode determination indicates the lossy mode 2 (step 703). When the determination result indicates the lossy mode 2 (Yes in step 703), a local-mode determination is made for each pixel block included in the line, and a determination result is output (step 704). The determination result of the local-mode determination indicates the lossy mode or the lossless mode.

Subsequently, the predictor 503 outputs a prediction error (step 705), and, according to the determination results of the wide-area-mode determination and the local-mode determination, the compressing unit 504 compresses the prediction error via lossy compression or lossless compression (step 706). Then, the counter 507 counts a generated-code amount (step 707).

Next, the line determining unit 505 determines whether or not an unprocessed compression-target pixel remains (step 708), and, when an unprocessed compression-target pixel remains (No in step 708), the line determining unit 505 repeats the processes of step 701 and the following steps.

When the input pixel is not the start pixel of one line in step 701 (No in step 701), the processes of step 703 and the following steps are performed; when the determination result does not indicate the lossy mode 2 in step 703 (No in step 703), the processes of step 705 and the following steps are performed. When an unprocessed compression-target pixel does not remain in step 708 (Yes in step 708), the process terminates.

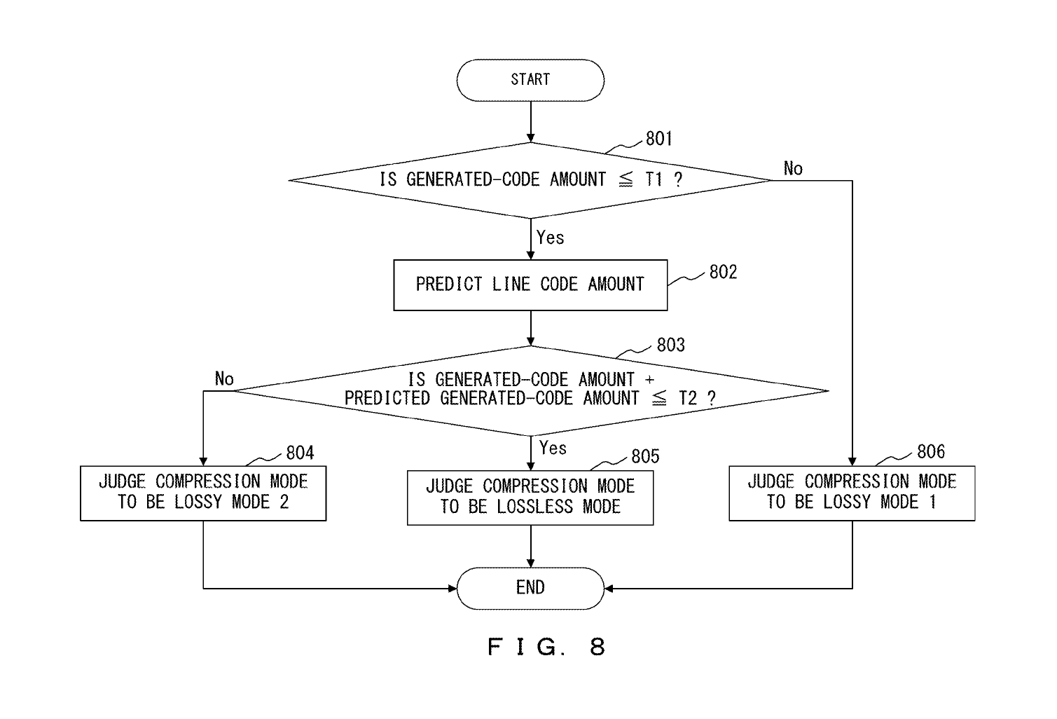

FIG. 8 is a flowchart illustrating an example of the wide-area-mode determination of step 702 of FIG. 7. First, the wide-area-mode determining unit 522 compares a generated-code amount output from the counter 507 with a threshold T1 (step 801). When the generated-code amount is greater than T1 (No in step 801), the compression mode of a compression-target line is judged to be the lossy mode 1 (step 806).

When the generated-code amount is equal to or less than T1 (Yes in step 801), the line-code-amount predicting unit 521 calculates a predicted generated-code amount according to the pixel value of the compression-target line (step 802).

The wide-area-mode determining unit 522 compares a code amount that is the sum of the predicted generated-code amount and the generated-code amount output from the counter 507 with a threshold T2 (step 803). When the code amount is greater than T2 (No in step 803), the compression mode of the compression-target line is judged to be the lossy mode 2 (step 804). Meanwhile, when the code amount is equal to or less than T2 (Yes in step 803), the compression mode of the compression-target line is judged to be the lossless mode (step 805).

Lossless compression is applied to a line for which the lossless mode is indicated as a result of the judgment, and lossy compression is applied to a line for which the lossy mode 1 is indicated as a result of the judgment. Lossless compression can be partly applied to a line for which the lossy mode 2 is indicated, so the compression mode is again determined in accordance with the local-mode determination.

T1 may be a value obtained by converting, with a predetermined compressibility, the total sum of the number of bits of the pixel values of all of the pixels included in a compressed line from among all of the lines of the compression-target image into the number of bits of compression code. T2 may be a value obtained by converting, with a predetermined compressibility, the total sum of the number of bits of the pixel values of all of the pixels included in the compressed line and the compression-target line into the number of bits of compression code. In this case, T1 and T2 are obtained in accordance with the following formulae, where k indicates the number of bits of the pixel value of each pixel, R indicates compressibility, and H indicates the number of horizontal pixels per line.

T1=RkH×(number of compressed lines) (11)

T2=RkH×(number of compressed lines+1) (12)

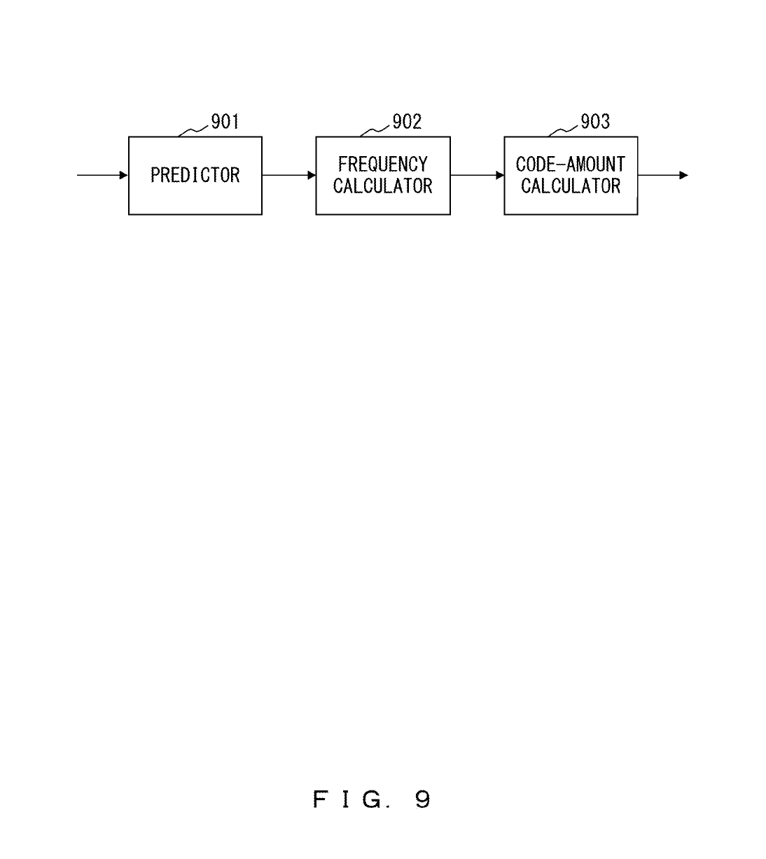

FIG. 9 illustrates a first exemplary functional configuration of the line-code-amount predicting unit 521 in FIG. 5. The line-code-amount predicting unit 521 of FIG. 9 includes a predictor 901, a frequency calculator 902, and a code-amount calculator 903.

Under a condition in which each pixel of an input compression-target line is a prediction-target pixel, the predictor 901 predicts the pixel value of the prediction-target pixel according to a predetermined prediction algorithm and outputs a prediction error. The prediction algorithm may be, for example, the plane prediction illustrated in FIG. 2, prediction with a pixel four pixels before, or prediction with a pixel eight pixels before, or another prediction algorithm may be used.

According to the prediction error output from the predictor 901 for each prediction-target pixel, the frequency calculator 902 calculates the frequency of appearance of each prediction error of the compression-target line. According to the obtained frequency of appearance, the code-amount calculator 903 calculates a predicted amount of generated code generated from the compression-target line.

For example, on the assumption that there are N kinds of prediction errors, the predicted amount (the number of bits) of generated code of the compression-target line is calculated by the following formula, where Err(i) indicates the frequency of appearance of the i-th (i=1, . . . , N) prediction error.

$$H \times {\sum }_{i = 1}^{N} ( Err ( i ) / H ) \times {log}_{2} ( H / Err ( i ) ) \qquad ( 13 )$$

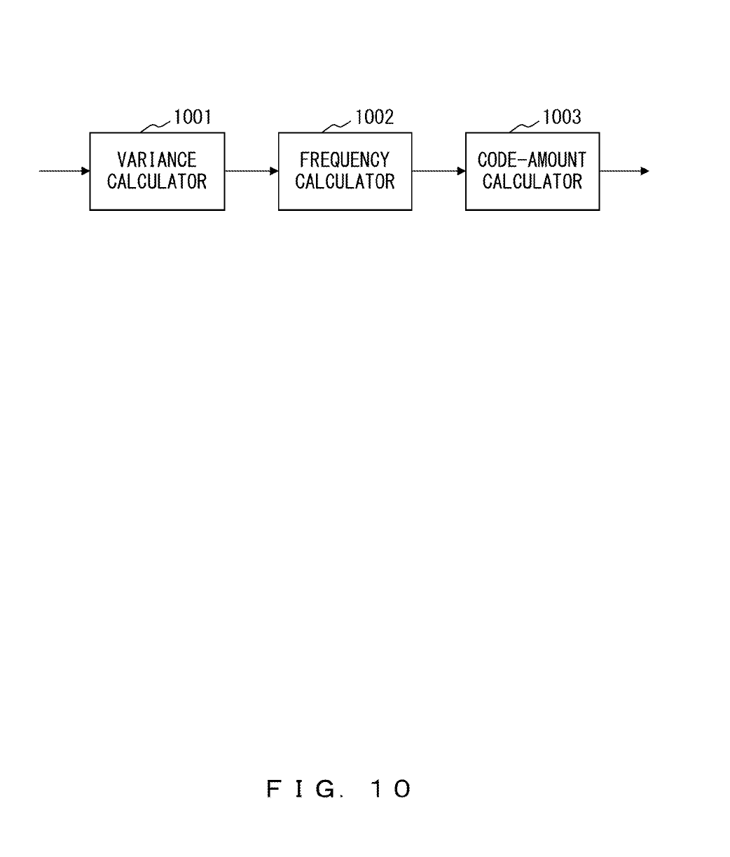

FIG. 10 illustrates a second exemplary functional configuration of the line-code-amount predicting unit 521 in FIG. 5. The line-code-amount predicting unit 521 of FIG. 10 includes a variance calculator 1001, a frequency calculator 1002, and a code-amount calculator 1003.

Under a condition in which each pixel of an input compression-target line is a prediction-target pixel, the variance calculator 1001 calculates the difference between the pixel value of the prediction-target pixel and each of the pixel values of eight pixels around the prediction-target pixel, and calculates a variance of the obtained differences.

According to the variance for each prediction-target pixel output from the variance calculator 1001, the frequency calculator 1002 calculates the frequency of appearance of each variance for the compression-target line. According to the obtained frequency of appearance, the code-amount calculator 1003 calculates a predicted amount of generated code generated from the compression-target line.

For example, on the assumption that there are N kinds of variances, the predicted amount (the number of bits) of generated code of the compression-target line is calculated by the following formula, where Stdev(i) indicates the frequency of appearance of the i-th (i=1, . . . , N) variance.

$$H \times {\sum }_{i = 1}^{N} ( Stdev ( i ) / H ) \times {log}_{2} ( H / Stdev ( i ) ) \qquad ( 14 )$$

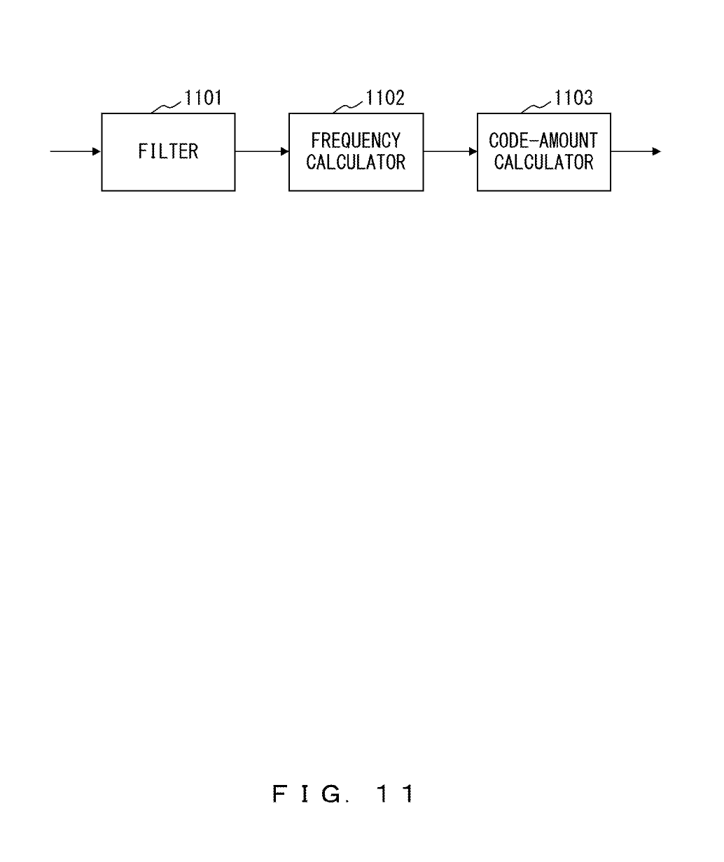

FIG. 11 illustrates a third exemplary functional configuration of the line-code-amount predicting unit 521 in FIG. 5. The line-code-amount predicting unit 521 of FIG. 11 includes a filter 1101, a frequency calculator 1102, and a code-amount calculator 1103.

Under a condition in which each pixel of an input compression-target line is a prediction-target pixel, the filter 1101 filters the pixel value of the prediction-target pixel according to a predetermined filtering algorithm, and outputs a filtering result. The filtering algorithm may be, for example, a Laplacian filter or may be another filtering algorithm.

According to the filtering result output from the filter 1101 for each prediction-target pixel, the frequency calculator 1102 calculates the frequency of appearance of each filtering result of the compression-target line. According to the obtained frequency of appearance, the code-amount calculator 1103 calculates a predicted amount of generated code generated from the compression-target line.

For example, on the assumption that there are N kinds of filtering results, the predicted amount (the number of bits) of generated code of the compression-target line is calculated by the following formula, where Filt(i) indicates the frequency of appearance of the i-th (i=1, . . . , N) filtering result.

$$H \times {\sum }_{i = 1}^{N} ( Filt ( i ) / H ) \times {log}_{2} ( H / Filt ( i ) ) \qquad ( 15 )$$

The configuration of the line-code-amount predicting unit 521 is not limited to those depicted in FIG. 9 to FIG. 11, and another configuration may be used to predict the code amount of compression code generated from one line.

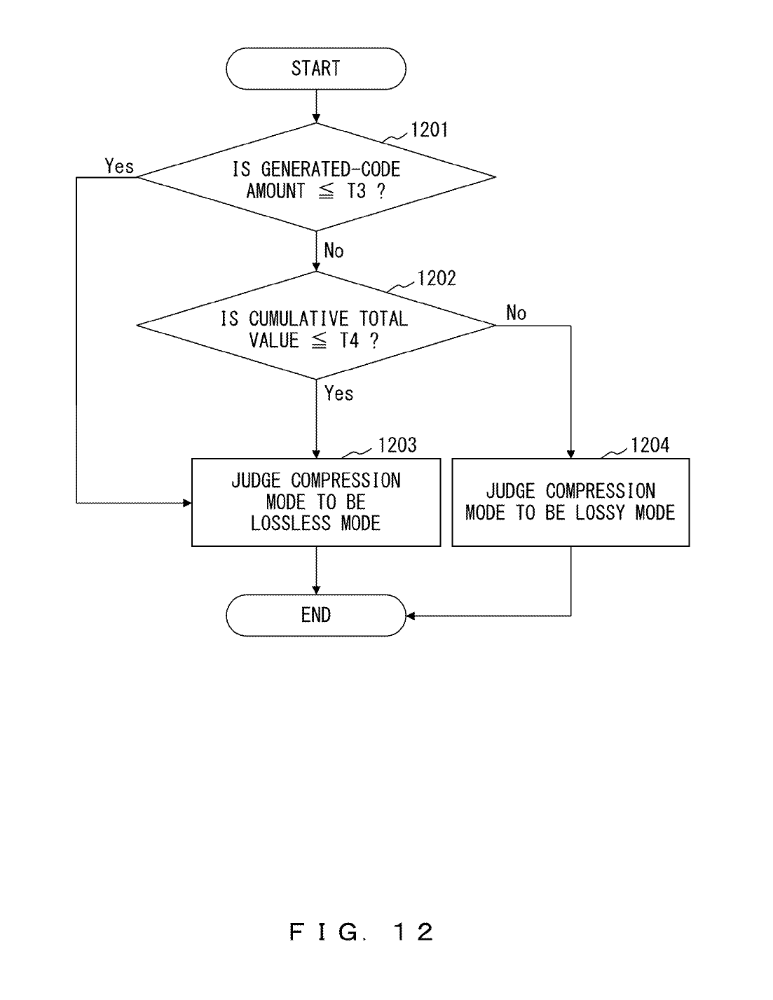

FIG. 12 is a flowchart illustrating an example of the local mode determination of step 704 in FIG. 7. First, the local-mode determining unit 532 compares a generated-code amount output from the counter 507 with a threshold T3 (step 1201). When the generated-code amount is equal to or less than T3 (Yes in step 1201), the compression mode of a compression-target pixel block is judged to be the lossless mode (step 1203).

When the generated-code amount is greater than T3 (No in step 1201), a cumulative total value output from the pixel-value comparing unit 531 is compared with a threshold T4 (step 1202). When the cumulative total value is greater than T4 (No in step 1202), the compression mode of the compression-target pixel block is judged to be the lossy mode (step 1204). Meanwhile, when the cumulative total value is equal to or less than T4 (Yes in step 1202), the compression mode of the compression-target pixel block is judged to be the lossless mode (step 1203).

Lossless compression is applied to a pixel block for which the lossless mode is indicated as a result of the judgment, and lossy compression is applied to a pixel block for which the lossy mode is indicated as a result of the judgment.

T3 may be a value obtained by converting, with a predetermined compressibility, the total sum of the number of bits of the pixel values of all of the pixels included in a compressed pixel block from among all of the pixel blocks of the compression-target image into the number of bits of compression code. In this case, T3 is obtained in accordance with the following formula, where B indicates the number of pixel blocks per line.

T3=RkH×(total number of lines)−Rk(H/B)×(number of remaining pixel blocks) (16)

The total number of lines indicates the total number of lines included in the compression-target image, and the number of remaining blocks indicates the number of uncompressed pixel blocks. T4 varies according to the type of a cumulative total value output from the pixel-value comparing unit 531.

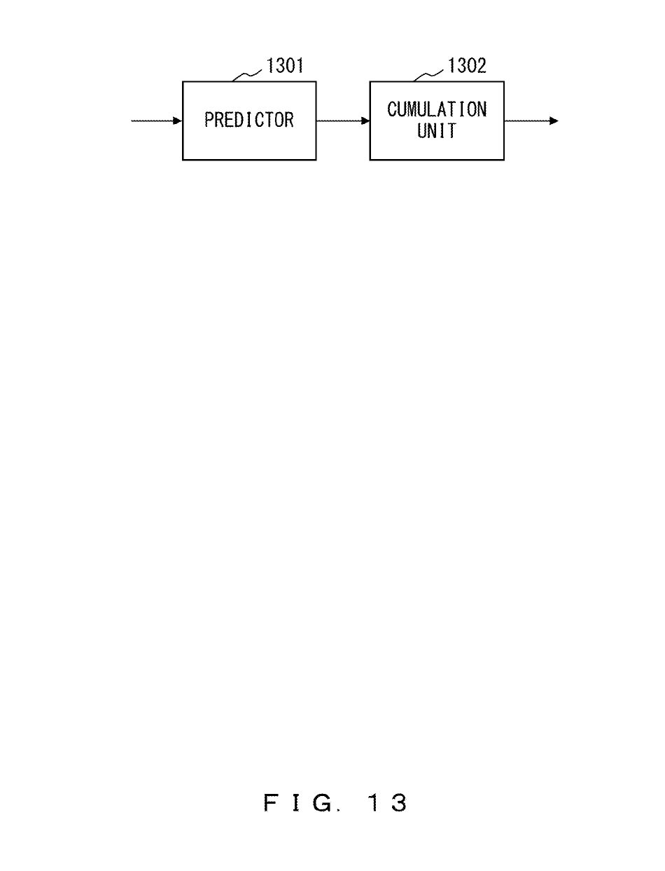

FIG. 13 illustrates a first exemplary functional configuration of the pixel-value comparing unit 531 in FIG. 5. The pixel-value comparing unit 531 of FIG. 13 includes a predictor 1301 and a cumulation unit 1302.

Under a condition in which each pixel of an input compression-target pixel block is a prediction-target pixel, the predictor 1301 predicts the pixel value of the prediction-target pixel according to a predetermined prediction algorithm and outputs a prediction error. The prediction algorithm may be, for example, the plane prediction illustrated in FIG. 2, prediction with a pixel four pixels before, or prediction with a pixel eight pixels before, or another prediction algorithm may be used. The cumulation unit 1302 calculates the cumulative total value of prediction errors for the prediction-target pixels output from the predictor 1301.

In this case, T4 may be a value that is based on the size of a quantization step used by the quantizer 512 for quantizing a prediction error. For example, T4 may be the product of the smallest unit of the quantization step size and the number of pixels per pixel block. In the case of the quantization table in FIG. 6, the smallest unit of the quantization step is “2”, and a smallest variable-length code is assigned to the value of a quantized prediction error that corresponds to this smallest unit. Thus, with the use of such a T4, lossless compression may be applied when the cumulative total value of prediction errors is equal to or less than T4, with the result that, without degrading the image quality, a region with small differences between the pixel values of pixels and with a small generated-code amount can be compressed.

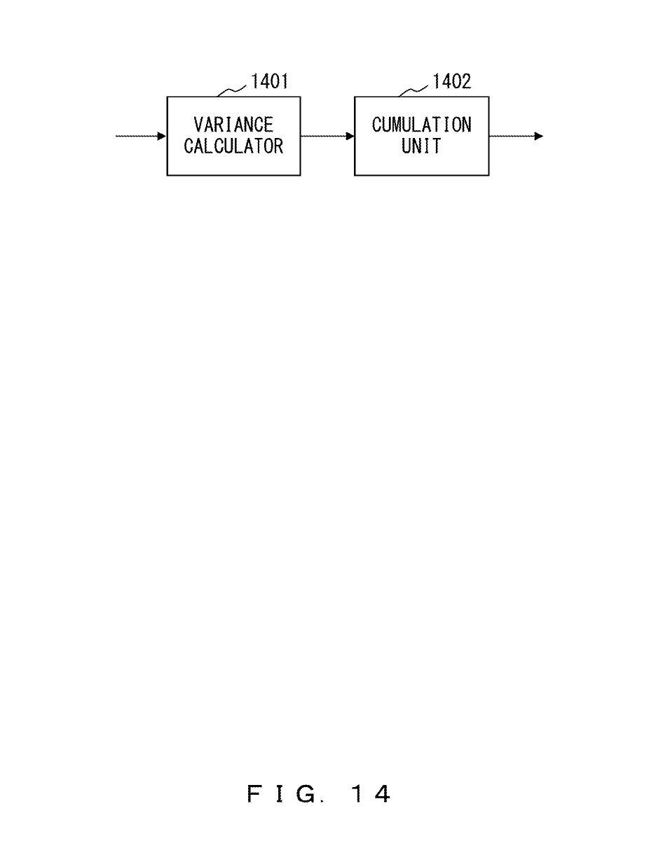

FIG. 14 illustrates a second exemplary functional configuration of the pixel-value comparing unit 531 in FIG. 5. The pixel-value comparing unit 531 of FIG. 14 includes a variance calculator 1401 and a cumulation unit 1402.

Under a condition in which each pixel of an input compression-target pixel block is a prediction-target pixel, the variance calculator 1401 calculates the difference between the pixel value of the prediction-target pixel and each of the pixel values of eight pixels around the prediction-target pixel, and calculates the variance of the obtained differences. The cumulation unit 1402 calculates the cumulative total value of prediction errors for the prediction-target pixels output from the variance calculator 1401.

In this case, T4 may be a value that is based on the variance of a pixel. For example, T4 may be the product of a variance corresponding to the smallest unit of the quantization step size and the number of pixels per pixel block.

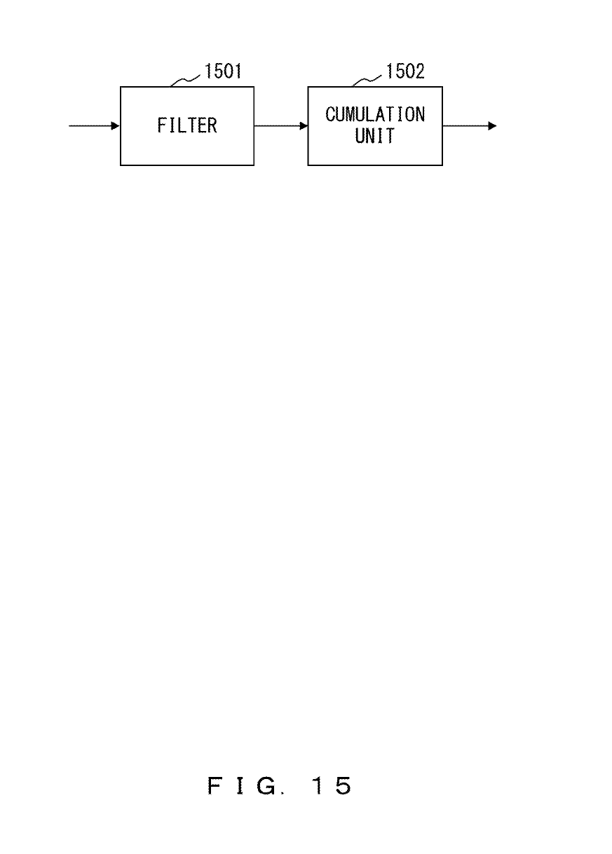

FIG. 15 illustrates a third exemplary functional configuration of the pixel-value comparing unit 531 in FIG. 5. The pixel-value comparing unit 531 of FIG. 15 includes a filter 1501 and a cumulation unit 1502.

Under a condition in which each pixel of an input compression-target pixel block is a prediction-target pixel, the filter 1501 filters the pixel value of the prediction-target pixel according to a predetermined filtering algorithm, and outputs a filtering result. The filtering algorithm may be, for example, a Laplacian filter or may be another filtering algorithm. The cumulation unit 1502 calculates the cumulative total value of filtering results for the prediction-target pixels output from the filter 1501.

In this case, T4 may be a value that is based on the filtering result of a pixel. For example, T4 may be the product of a filtering result corresponding to the smallest unit of the quantization step size and the number of pixels per pixel block.

The configuration of the pixel-value comparing unit 531 is not limited to those illustrated in FIG. 13 to FIG. 15, and another configuration may be used in which the pixel value of each pixel is compared with the pixel values of neighboring pixels around the pixel, and the cumulative value of the comparison results for one block is calculated.

In step 706 in FIG. 7, the selecting units 511 and 514 select the quantizer 512 for a pixel for which the lossy mode 1 (step 806) or the lossy mode (step 1204) is indicated as a result of the judgment. Meanwhile, the selecting units 511 and 514 select the non-quantization path 513 for a pixel for which the lossless mode (step 1203) is indicated as a result of the judgment.

A variable-length coder 905 generates compression code in a form such that the determination result of the wide-area-mode determination, the determination result of the local-mode determination, and the output of the quantizer 512 or the non-quantization path 513 are distinguishable from each other. The determination result of the wide-area-mode determination and the determination result of the local-mode determination are respectively converted into a wide-area-mode flag and a local-mode flag.

For each line, a wide-area-mode flag is output when the beginning pixel of the line is compressed. The wide-area-mode flag indicates the lossy mode 1, the lossy mode 2, or the lossless mode. For example, for the lossy mode 1, a fixed-length bit of “00” is output; for the lossy mode 2, a fixed-length bit of “01”; for the lossless mode, a fixed-length bit of “10”.

For each pixel block of a line for which the lossy mode 2 is indicated by the wide-area-mode determination, a local-mode flag is output when the beginning pixel of the pixel block is compressed. The local-mode flag indicates the lossy mode or the lossless mode. For example, for the lossy mode, a fixed-length bit of “0” is output; for the lossless mode, a fixed-length bit of “1”.

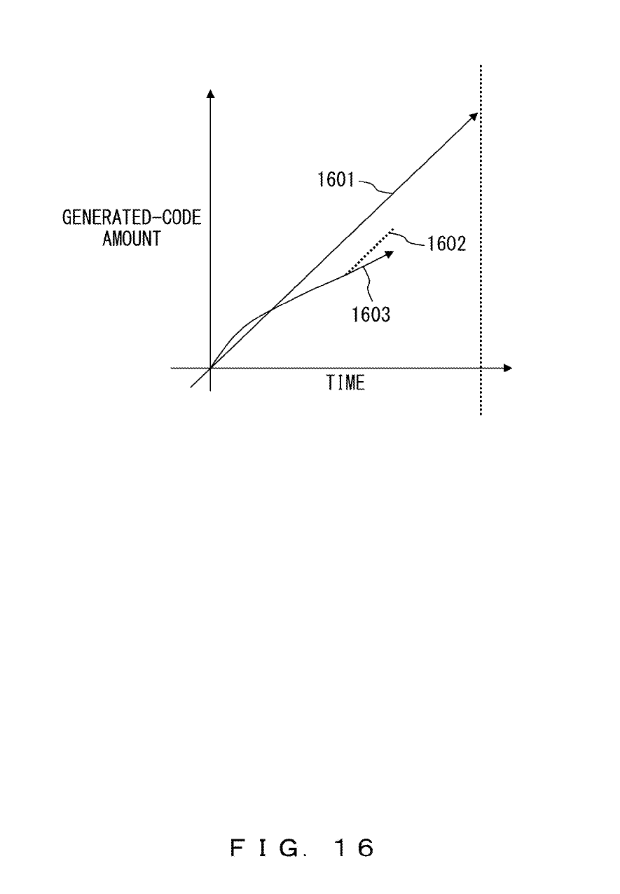

FIG. 16 illustrates a change in a generated-code amount with respect to a time that has elapsed after the start of the compressing of a compression-target image. A straight line 1601 indicates a change in a generated-code amount associated with compression with a predetermined constant compressibility; a dashed line 1602 indicates a change in the threshold T1 in step 801 of FIG. 8; a curved line 1603 indicates a generated-code amount output from the counter 507.

When a generated-code amount 1603 is equal to or less than a threshold 1602, lossless compression may be applied to a compression-target line, thereby triggering the determination of step 803, and the lossy mode 2 or the lossless mode is output as a determination result of the wide-area-mode determination. In this case, when the lossless mode is indicated, lossless compression is applied to the entirety of the compression-target line, so that regions with no image-quality degradation can be increased on a line-by-line basis while satisfying a condition on the compressibility.

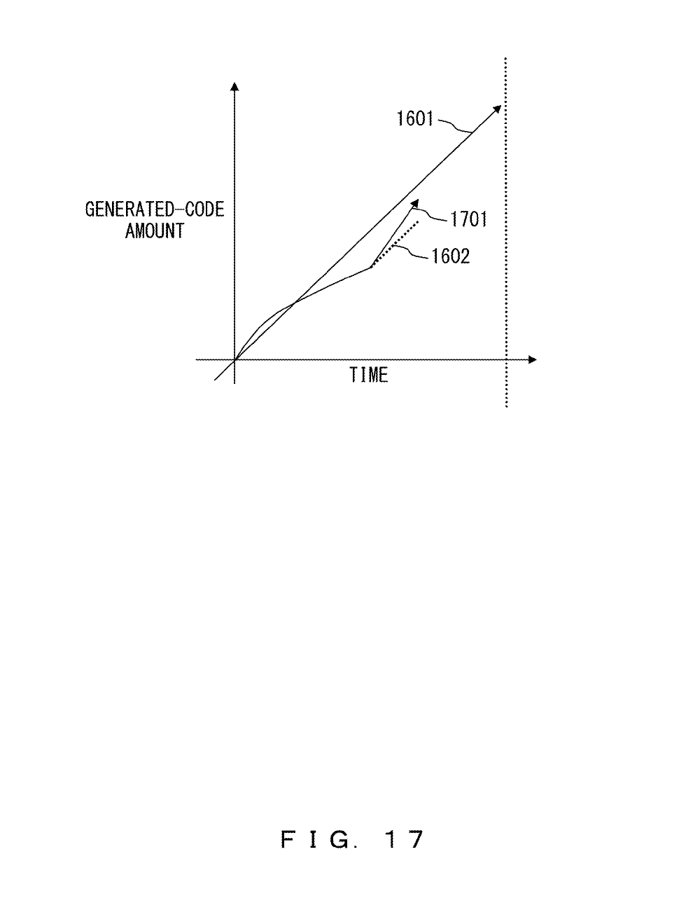

Meanwhile, when a generated-code amount 1701 exceeds a threshold 1602 as illustrated in FIG. 17, lossy compression is applied to a compression-target line, and the lossy mode 1 is output as a determination result of the wide-area-mode determination.

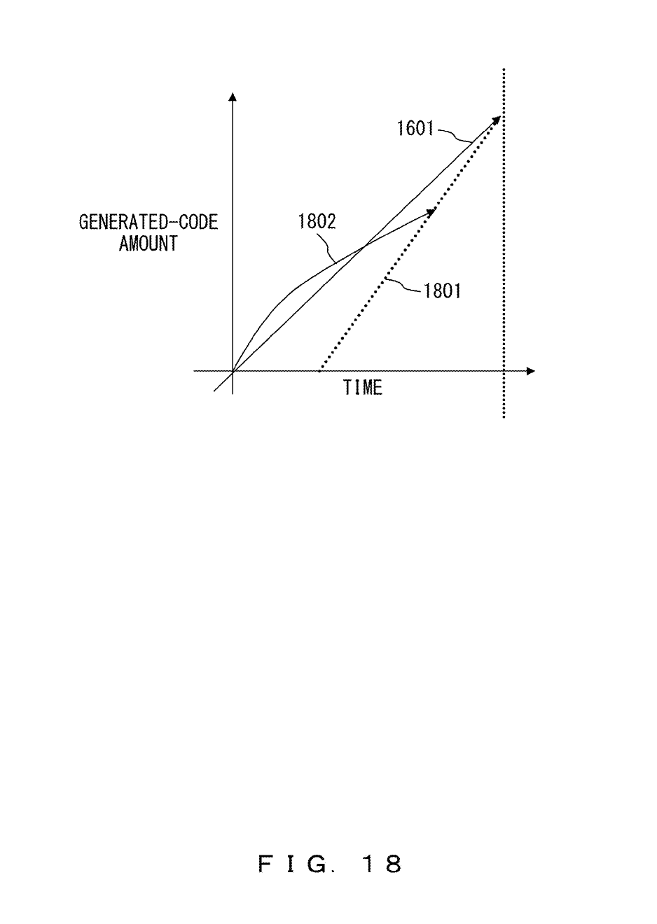

FIG. 18 illustrates a change in a generated-code amount that is made after the mode is judged to be the lossy mode 2 in step 803. A dashed line 1801 indicates a change in the threshold T3 in step 1201 of FIG. 12. When a generated-code amount 1802 output from the counter 507 is equal to or less than a threshold 1801, lossless compression may be applied to the compression-target pixel block, thereby outputting the lossless mode as a determination result of the local-mode determination. In this case, lossless compression is applied to the entirety of the compression-target pixel block, so that regions with no image-quality degradation can be increased on a pixel-block by pixel-block basis while satisfying a condition on the compressibility.

In accordance with the configuration of FIG. 5, the wide-area-mode determination and the local-mode determination may be achieved by simply providing the line buffer 501 and the pixel block buffer 502, thereby satisfying conditions of a high image quality, low delay, and light weight.

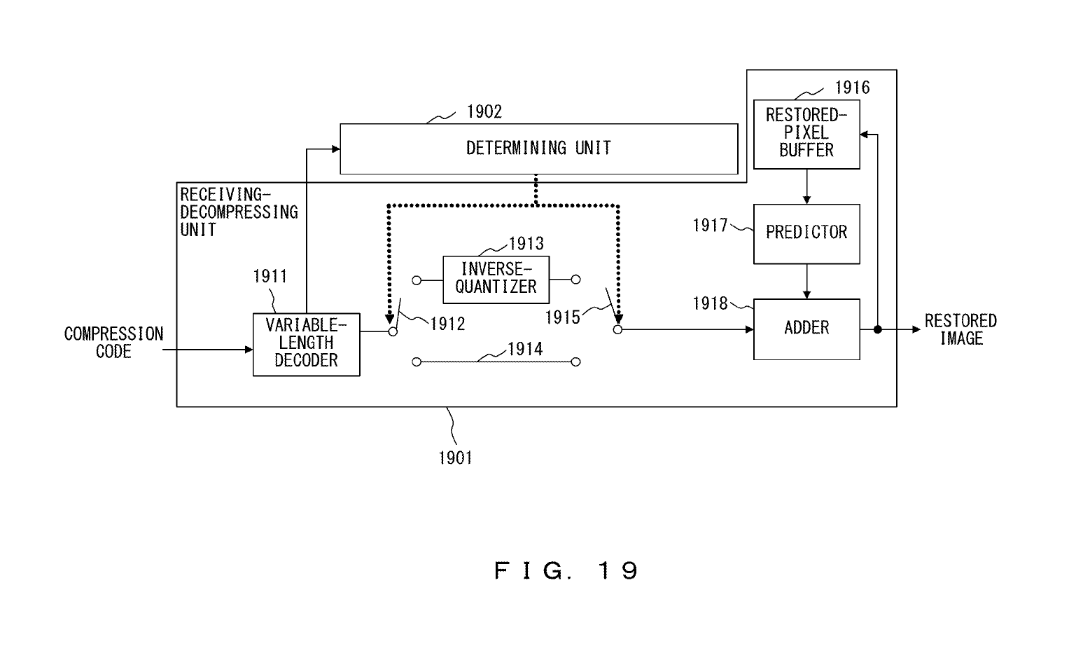

Next, with reference to FIG. 19 to FIG. 21, descriptions will be given of a configuration and an operation of an image decompressing apparatus that restores an original image from a compression code.

FIG. 19 illustrates an exemplary functional configuration of an image decompressing apparatus. The image decompressing apparatus of FIG. 19 includes a receiving-decompressing unit 1901 and a determining unit 1902. The receiving-decompressing unit 1901, which corresponds to the receiving unit 421 and the decompressing unit 422 in FIG. 4, includes a variable-length decoder 1911, selecting units 1912 and 1915, an inverse-quantizer 1913, a non-quantization path 1914, a restored-pixel buffer 1916, a predictor 1917, and an adder 1918.

The variable-length decoder 1911 receives a compression code output from the image compression apparatus and extracts a wide-area-mode flag, a local-mode flag, and a code part from the compression code. Then, the variable-length decoder 1911 outputs the wide-area-mode flag and the local-mode flag to the determining unit 1902 as compression information, applies variable-length decoding to the code part, and outputs a decoding result to the selecting unit 1912. The wide-area-mode flag is extracted from the beginning of each line, and the local-mode flag is extracted from the beginning of each pixel block.

The determining unit 1902 determines the compression mode of the code part according to the values of the wide-area-mode flag and the local-mode flag and outputs a determination result to the selecting units 1912 and 1915. According to the determination result of the determining unit 1902, the selecting units 1912 and 1915 select one of the inverse-quantizer 1913 and the non-quantization path 1914. The inverse-quantizer 1913 inverse-quantizes a decoding result so as to output a prediction error, and the non-quantization path 1914 directly outputs a prediction error that is a decoding result.

The adder 1918 sums the predicted value output from the predictor 1917 and the prediction error output from the selecting unit 1915 so as to output the pixel value of a restoration-target pixel. The restored-pixel buffer 1916 stores the pixel value output from the adder 1918 as the pixel value of a neighboring restored pixel. Using the pixel value of the neighboring restored pixel, the predictor 1917 predicts the pixel value of the restoration-target pixel according to a prediction algorithm that corresponds to the predictor 503 in FIG. 5, and outputs a predicted value.

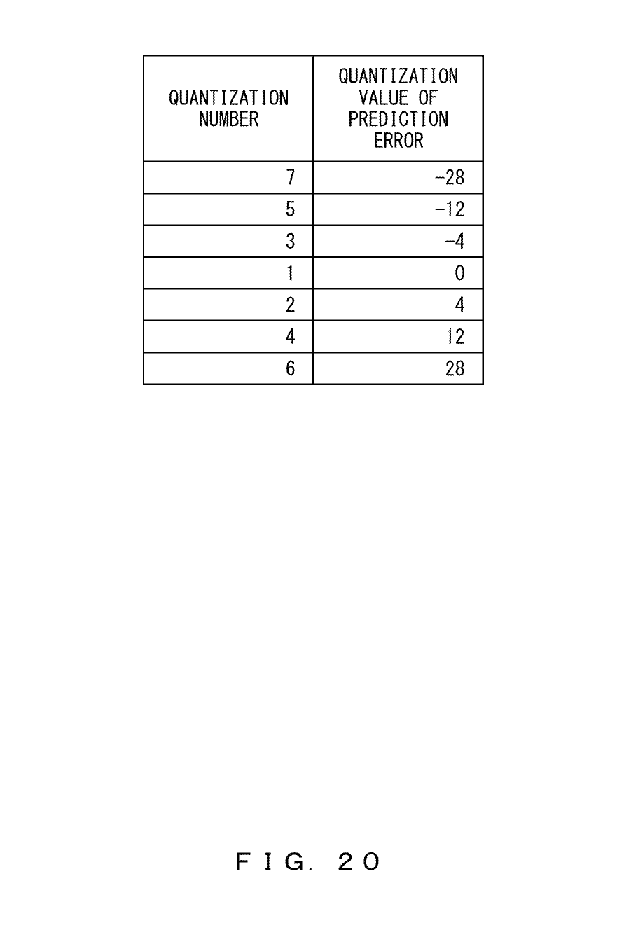

FIG. 20 illustrates an exemplary inverse quantization table used by the inverse-quantizer 1913 for inverse quantization. The inverse-quantizer 1913 converts a quantization number that is a decoding result output from the selecting unit 1912 into a quantization value of a corresponding prediction error. As quantization numbers and quantization values of the inverse quantization table, the values corresponding to the quantization table used by the quantizer 512 in FIG. 5 are used.

An image decompressing process that uses a prediction error output from the inverse-quantizer 1913 corresponds to lossy decompression, and an image decompressing process that uses a prediction error output from the non-quantization path 1914 corresponds to lossless decompression.

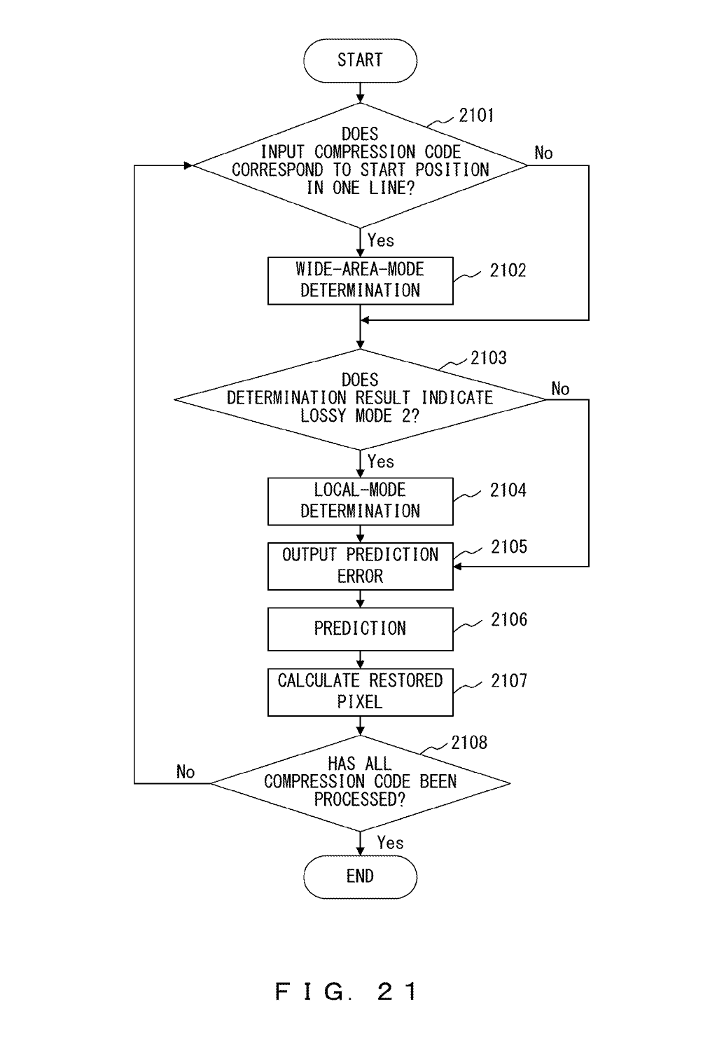

FIG. 21 is a flowchart illustrating an exemplary image decompressing process performed by the image decompressing apparatus of FIG. 19. First, the variable-length decoder 1911 determines whether or not an input compression code corresponds to a start position in one line (step 2101). When the input compression code corresponds to a start position in one line (Yes in step 2101), a wide-area-mode flag is extracted and output to the determining unit 1902.

The determining unit 1902 makes the wide-area-mode determination so as to determine which of the lossy mode 1, the lossy mode 2, and the lossless mode is indicated by the wide-area-mode flag (step 2102). When the determination result of the wide-area-mode determination indicates the lossy mode 2 (Yes in step 2103), the local-mode determination is made to determine which of the lossy mode and the lossless mode is indicated by each local-mode flag included in the line (step 2104).

Next, the variable-length decoder 1911 decodes code part corresponding to the pixels, and outputs a decoding result. According to the determination results of the wide-area-mode determination and the local-mode determination, the selecting units 1912 and 1915, the inverse-quantizer 1913, and the non-quantization path 1914 output a prediction error corresponding to the decoding result (step 2105).

When the determination result of the wide-area-mode determination indicates the lossy mode 1 or the determination result of the local-mode determination indicates the lossy mode, the selecting units 1912 and 1915 select the inverse-quantizer 1913. In this case, the prediction error from the inverse-quantizer 1913 is output to the adder 1918.

Meanwhile, when the determination result of the wide-area-mode determination or the local-mode determination indicates the lossless mode, the selecting units 1912 and 1915 select the non-quantization path 1914. In this case, the prediction error from the non-quantization path 1914 is output to the adder 1918.

Next, the predictor 1917 outputs a predicted value (step 2106), and the adder 1918 adds the prediction error to the predicted value so as to calculate the pixel value of the restoration-target pixel (step 2107).

Next, the variable-length decoder 1911 determines whether or not unprocessed compression code remains (step 2108), and, when unprocessed compression code remains (No in step 2108), the processes of step 2101 and the following steps are repeated.

When the input compression code does not correspond to a start position in one line in step 2101 (No in step 2101), the processes of step 2103 and the following steps are performed. When the determination result does not indicate the lossy mode 2 in step 2103 (No in step 2103), the processes of step 2105 and the following steps are performed. When unprocessed compression code does not remain in step 2108 (Yes in step 2108), the process terminates.

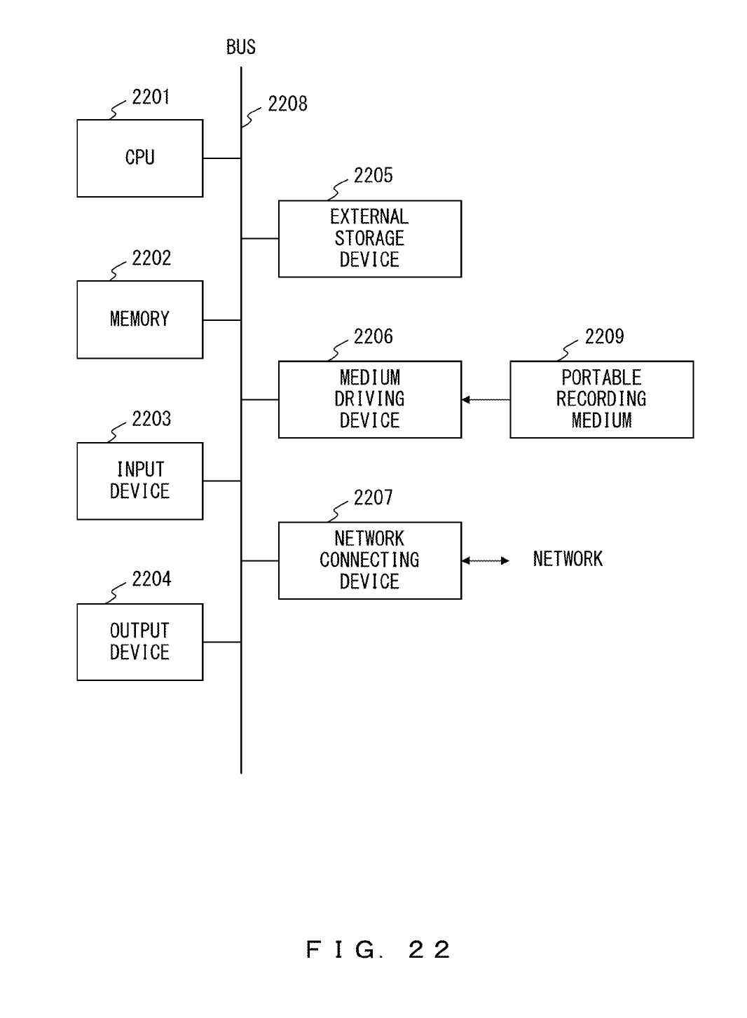

The image compressing apparatus 401 and the image decompressing apparatus 402 in FIG. 4, the image compressing apparatus of FIG. 5, and the image decompressing apparatus of FIG. 19 are achievable using, for example, an information processing apparatus (a computer) such as that depicted in FIG. 22.

The information processing apparatus of FIG. 22 includes a central processing unit (CPU) 2201, a memory 2202, an input device 2203, an output device 2204, an external storage device 2205, a medium driving device 2206, and a network connecting device 2207. These elements are connected to each other via a bus 2208.

The memory 2202 is, for example, a semiconductor memory such as a read only memory (ROM), a random access memory (RAM), or a flash memory, and the memory 2202 stores a program and data used for an image compressing process or an image decompressing process. For example, the CPU 2201 (a processor) performs an image compressing process or an image decompressing process by executing a program using the memory 2202. The memory 2202 may be used as the line buffer 501 and the pixel block buffer 502 in FIG. 5 or the restored-pixel buffer 1916 in FIG. 19.

For the image compressing apparatus 401 in FIG. 4, the CPU 2201 operates as the predictor 411, the compressing unit 412, and the line determining unit 413. For the image decompressing apparatus 402 in FIG. 4, the CPU 2201 operates as the decompressing unit 422 and the determining unit 423.

For the image compressing apparatus in FIG. 5, the CPU 2201 operates as the predictor 503, the compressing unit 504, the line determining unit 505, the pixel block determining unit 506, and the counter 507. In addition, the CPU 2201 also operates as the selecting units 511 and 514, the quantizer 512, the variable-length coder 515, the line-code-amount predicting unit 521, the wide-area-mode determining unit 522, the pixel-value comparing unit 531, and the local-mode determining unit 532.

For the image decompressing apparatus in FIG. 19, the CPU 2201 operates as the receiving-decompressing unit 1901 and the determining unit 1902. In addition, the CPU 2201 also operates as the variable-length decoder 1911, the selecting units 1912 and 1915, the inverse-quantizer 1913, the predictor 1917, and the adder 1918.

The input device 2203 is, for example, a keyboard or a pointing device and is used to input information and an instruction from a user or an operator. The output device 2204 is, for example, a display device, a printer, or a speaker and is used to output a query and a processing result to a user or an operator. The processing result includes a restored image.

The external storage device 2205 is, for example, a magnetic disk device, an optical disk device, a magnetic-optical disk device, or a tape device. The external storage device 2205 also includes a hard disk drive. The information processing apparatus may store a program and data in the external storage device 2205 and may use the stored program and the stored data by loading them into the memory 2202.

The medium driving device 2206 drives a portable recording medium 2209 and accesses a recorded content of the portable recording medium 2209. The portable recording medium 2209 is, for example, a memory device, a flexible disk, an optical disk, or a magnetic-optical disk. The portable recording medium 2209 also includes, for example, a compact disk read only memory (CD-ROM), a digital versatile disk (DVD), and a universal serial bus (USB) memory. The user or the operator may store a program and data in the portable recording medium 2209 and may use the stored program and the stored data by loading them into the memory 2202.

As described above, computer-readable record media that store a program and data used for an image compressing process or an image decompressing process include physical (non-transitory) recording media such as the memory 2202, the external storage device 2205, and the portable recording medium 2209.

The network connecting device 2207 is a communication interface that is connected to a communication network such as a local area network (LAN) and that converts data in association with a communication. The network connecting device 2207 transmits a generated compression code to the image decompressing apparatus or receives compression code from the image compressing apparatus. The information processing apparatus may receive a program and data from an external apparatus via the network connecting device 2207 and may use the stored program and the stored data by loading them into the memory 2202.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image compressing apparatus that uses a prediction coding scheme, the image compressing apparatus comprising:
a processor configured to
generate a prediction error by predicting a pixel value of a prediction-target pixel in a compression-target image,
predict a code amount of compression code for a compression-target line in the compression-target image,
according to the predicted code amount and a code amount of compression code for one or more compressed lines, determine which of lossless compression and lossy compression is to be applied to the compression-target line, and
when the processor determines that lossless compression is to be applied, generate the compression code for the compression-target line by compressing a prediction error for each compression-target pixel of the compression-target line via lossless compression.

2. The image compressing apparatus according to claim 1, wherein
when the processor determines that lossy compression is to be applied, according to a comparison result of a comparison between a first pixel value of a prediction-target pixel included in a compression-target pixel block in the compression-target line and a second pixel value of a pixel around the prediction-target pixel included in the compression-target pixel block, the processor determines which of lossless compression and lossy compression is to be applied to the compression-target pixel block,
when the processor determines that lossless compression is to be applied, the processor generates compression code for the compression-target pixel block by compressing a prediction error for each prediction-target pixel in the compression-target pixel block via lossless compression, and
when the processor determines that lossy compression is to be applied, the processor generates compression code for the compression-target pixel block by compressing a prediction error for each prediction-target pixel in the compression-target pixel block via lossy compression.

3. The image compressing apparatus according to claim 2, further comprising:
a line buffer configured to store a pixel value of each prediction-target pixel in the compression-target line, wherein
the processor predicts the code amount of the compression code for the compression-target line by using a pixel value input to the line buffer, and generates the comparison result by using a pixel value output from the line buffer.

4. The image compressing apparatus according to claim 1, wherein
the processor predicts the code amount of the compression code for the compression-target line according to the prediction error for each prediction-target pixel in the compression-target line, a variance of differences between a first pixel value of each prediction-target pixel in the compression-target line and a second pixel value of a pixel around each prediction-target pixel in the compression-target line, or a filtering result of filtering each prediction-target pixel in the compression-target line.

5. The image compressing apparatus according to claim 2, wherein
the processor generates the comparison result according to the prediction error for each prediction-target pixel in the compression-target pixel block, a variance of differences between the first pixel value and the second pixel value for each prediction-target pixel in the compression-target pixel block, or a filtering result of filtering each prediction-target pixel in the compression-target pixel block.

6. An image decompressing apparatus that uses a prediction coding scheme, the image decompressing apparatus comprising:
a receiving unit configured to
receive compression code for a compression-target line in a compression-target image, wherein the compression code is generated by generating a prediction error by predicting a pixel value of a prediction-target pixel in the compression-target image, by predicting a code amount of the compression code for the compression-target line, by determining which of lossless compression and lossy compression is to be applied to the compression-target line according to the predicted code amount and a code amount of compression code for one or more compressed lines, and by compressing a prediction error for each prediction-target pixel in the compression-target line via lossless compression when lossless compression is determined to be applied, and
receive compression information indicating a determination result of the determining which of lossless compression and lossy compression is to be applied; and
a processor configured to
determine which of lossless compression and lossy compression is indicated by the compression information, and
when the compression information indicates lossless compression, restore an image of the compression-target line from the compression code for the compression-target line via lossless decompression.

7. A computer-readable recording medium having stored therein a program for causing a computer to execute an image compressing process that uses a prediction coding scheme, the image compressing process comprising:
predicting a code amount of compression code for a compression-target line in a compression-target image;
according to the predicted code amount and a code amount of compression code for one or more compressed lines, determining which of lossless compression and lossy compression is to be applied to the compression-target line;
generating a prediction error by predicting a pixel value of each prediction-target pixel in the compression-target line; and
when lossless compression is determined to be applied, generating the compression code for the compression-target line by compressing the prediction error for each compression-target pixel in the compression-target line via lossless compression.

8. The computer-readable recording medium according to claim 7, wherein
the image compressing process further comprises:
when lossy compression is determined to be applied, according to a comparison result of a comparison between a first pixel value of a prediction-target pixel included in a compression-target pixel block in the compression-target line and a second pixel value of a pixel around the prediction-target pixel included in the compression-target pixel block, determining which of lossless compression and lossy compression is to be applied to the compression-target pixel block, wherein
when lossless compression is determined to be applied to the compression-target pixel block, the generating the compression code generates compression code for the compression-target pixel block by compressing the prediction error for each prediction-target pixel in the compression-target pixel block via lossless compression, and
when lossy compression is determined to be applied to the compression-target pixel block, the generating the compression code generates compression code for the compression-target pixel block by compressing the prediction error for each prediction-target pixel in the compression-target pixel block via lossy compression.

9. The computer-readable recording medium according to claim 8, wherein
the determining which of lossless compression and lossy compression is to be applied to the compression-target line predicts the code amount of the compression code for the compression-target line by using a pixel value input to a line buffer that stores a pixel value of each prediction-target pixel in the compression-target line, and
the determining which of lossless compression and lossy compression is to be applied to the compression-target pixel block generates the comparison result by using a pixel value output from the line buffer.

10. The computer-readable recording medium according to claim 7, wherein
the determining which of lossless compression and lossy compression is to be applied to the compression-target line predicts the code amount of the compression code for the compression-target line according to the prediction error for each prediction-target pixel in the compression-target line, a variance of differences between a first pixel value of each prediction-target pixel in the compression-target line and a second pixel value of a pixel around each prediction-target pixel in the compression-target line, or a filtering result of filtering each prediction-target pixel in the compression-target line.

11. The computer-readable recording medium according to claim 8, wherein
the determining which of lossless compression and lossy compression is to be applied to the compression-target pixel block generates the comparison result according to a prediction error for each prediction-target pixel in the compression-target pixel block, a variance of differences between the first pixel value and the second pixel value for each prediction-target pixel in the compression-target pixel block, or a filtering result of filtering each prediction-target pixel in the compression-target pixel block.

12. A computer-readable recording medium having stored therein a program for causing a computer to execute an image decompressing process that uses a prediction coding scheme, the image decompressing process comprising:
receiving compression code for a compression-target line generated in a compression-target image, wherein the compression code is generated by generating a prediction error by predicting a pixel value of a prediction-target pixel in the compression-target image, by predicting a code amount of the compression code for the compression-target line, by determining which of lossless compression and lossy compression is to be applied to the compression-target line according to the predicted code amount and a code amount of compression code for one or more compressed lines, and by compressing a prediction error for each prediction-target pixel in the compression-target line via lossless compression when lossless compression is determined to be applied;
receiving compression information indicating a determination result of the determining which of lossless compression and lossy compression is to be applied;
determining which of lossless compression and lossy compression is indicated by the compression information; and
when the compression information indicates lossless compression, restoring an image of the compression-target line from the compression code for the compression-target line via lossless decompression.
